(19) United States
(12) Patent Application Publication
(10) Pub. No.: US 2015/0004282 A1
(43) Pub. Date: Jan. 1, 2015

(54) DIETARY SUPPLEMENTS CONTAINING CAFFEINE AND NIACIN

(71) Applicant: Pacific Shore Holdings, Inc., Chatsworth, CA (US)

(72) Inventor: Matthew Mills, West Hills, CA (US)

(73) Assignee: Pacific Shore Holdings, Inc., Chatsworth, CA (US)

(21) Appl. No.: 14/370,893

(22) PCT Filed: Jan. 9, 2013
(86) PCT No.: PCT/US13/20742

§ 371 Date: Jul. 7, 2014

Related U.S. Application Data
(60) Provisional application No. 61/584,405, filed on Jan. 9, 2012.

(51) Int. Cl. A23L 1/302; A23L 1/30

(52) U.S. Cl. CPC A23L 1/302; A23L 1/3002; A23V 2002/00
USPC 426/72

(57) ABSTRACT

Dietary supplements that can provide energy to a user are described herein. The dietary supplements can contain a delivery matrix suitable for being added to a foodstuff, caffeine and niacin. The dietary supplements can be odorless and flavorless. The caffeine can be provided by green coffee bean extract. Other components, including green tea extract, can also be present.

### CROSS-REFERENCE TO RELATED APPLICATIONS

This application claims the benefit of priority under 35 U.S.C. §119 from U.S. Provisional Patent Application 61/584,405, filed Jan. 9, 2012, which is incorporated herein by reference in its entirety.

### STATEMENT REGARDING FEDERALLY SPONSORED RESEARCH OR DEVELOPMENT

Not applicable.

### BACKGROUND

The present disclosure relates to dietary supplements, and, more specifically, to dietary supplements that can provide energy to a user.

There are many factors that can influence a person's energy levels throughout the day. Nutrient deficiencies, insufficient carbohydrate loads, stress, depression, fatigue and lack of restorative sleep can all affect liveliness and alertness. Dietary supplements that can combat one or more of the foregoing factors and provide energy to a user represent a growing sector of the nutraceuticals market. In some instances, such dietary supplements can be ingested in pill form by a user in response to situations where a boost of energy is needed. Energy drinks that provide similar benefits also represent a growing segment of the beverage market.

Despite the growing demand for energy restorative supplements, particularly energy drinks, there has yet to be developed a general way for users to more casually enjoy their benefits. For example, energy supplements in pill form may be difficult for some users to ingest and inconvenient to use on an ongoing basis. In addition, many currently available energy drinks are expensive, calorie-laden, and may have an undesirable taste for some users. For users unable to enjoy currently available energy supplements, either in liquid or pill forms, there are few energy-boosting alternatives available. Moreover, presently available energy supplements do not provide a general way in which a variety of foods or beverages may be enhanced for boosting one's energy, but without significantly altering the food or beverage's taste, odor, or consistency. The present disclosure addresses the foregoing needs and provides related advantages as well.

### SUMMARY

The present disclosure relates to dietary supplements, and, more specifically, to dietary supplements that can provide energy to a user.

In various embodiments, the present disclosure describes dietary supplements comprising: a delivery matrix suitable for being added to a foodstuff; niacin; and caffeine; wherein the dietary supplements are odorless and flavorless.

In various embodiments, the present disclosure describes dietary supplements comprising: a liquid delivery matrix suitable for being added to a foodstuff; niacin; green coffee bean extract, containing caffeine; and green tea extract; wherein the dietary supplements are odorless and flavorless.

In various embodiments, the present disclosure describes foodstuffs enhanced with the dietary supplements described herein.

The features and advantages of the present disclosure will be readily apparent to one having ordinary skill in the art upon a reading of the description of the embodiments that follows.

### BRIEF DESCRIPTION OF THE DRAWINGS

Not applicable.

### DETAILED DESCRIPTION

The present disclosure relates to dietary supplements, and, more specifically, to dietary supplements that can provide energy to a user.

In various embodiments, the dietary supplements described herein can contain caffeine and niacin. Niacin (also known as Vitamin B3, nicotinic acid, or Vitamin PP) plays a key role in the metabolism of proteins, fats and carbohydrates into energy. In addition, niacin is purported to promote a number of other health benefits including, for example, possibly decreasing the risk of coronary artery disease. Niacin is present in a number of natural sources including, for example, meats and fortified grain products. Caffeine is a stimulant that is present in a variety of natural sources, including coffee and tea, for example. In addition to providing a convenient natural source of caffeine, extracts of coffee and tea can supply antioxidant compounds (such as polyphenols) that can further promote beneficial health effects. Thus, dietary supplements containing both niacin and caffeine may boost a user's energy level via a dual and synergistic mechanism of action, while also providing the user with other beneficial health effects. Other B vitamins as well as additional substances may further promote these beneficial health effects.

A particularly desirable feature of the dietary supplements described herein is that they may be added to a wide array of foodstuffs, but without significantly altering the foodstuff's taste, odor and/or consistency. As defined herein, the term “foodstuff” will be used to refer to a food or a beverage. Illustrative foodstuffs that may be enhanced with the dietary supplements described herein include, for example, alcoholic beverages (e.g., cocktails, wine, beer, hard liquor, and the like), carbonated beverages, water (e.g., bottled water, mineral water, sparkling water, tap water, and the like), fruit juices, vegetable juices, milk, sports drinks, cooking oils, salad dressings, condiments, soups, and the like. The foodstuffs may be predominantly in fluid form, such as the foregoing foodstuffs, or they may be in a more solid form. Accordingly, the dietary supplements described herein may be used to significantly broaden the types of energy-boosting foodstuffs that are available for consumption by a user. More importantly, since the dietary supplements do not significantly change the taste and/or odor of the foodstuffs, they may continue to be enjoyed by a user in substantially the same manner as that of their everyday consumption. Moreover, foodstuffs enhanced with the present dietary supplements may be enjoyed in settings where typical energy drinks are either unavailable for purchase or not socially acceptable for consumption, such as at fine dining establishments or in a bar.

When combined with alcoholic beverages, the present dietary supplements may provide an additional user benefit of reducing the aftereffects of alcohol consumption. That is, the dietary supplements may assist in reducing “hangover” effects being experienced by a user. In a like manner, the dietary supplements may be combined with other foodstuffs after or while consuming alcoholic beverages to combat the effects of a hangover. Without being bound by any theory or mechanism, it is believed that the niacin and/or other B vitamins may promote the reduction of such hangover-related effects.

Further, in some embodiments, the dietary supplements may be formulated to suppress a user's appetite, which can also be beneficial to one's overall health. Specifically, the dietary supplements of the present disclosure may also contain an appetite suppressant such as, for example, Hoodia gordonii extract in order to decrease a user's desire to consume food. Further details regarding the benefits of Hoodia gordonii extract for use in appetite suppression may be found in commonly owned U.S. patent application Ser. No. 13/700,894, filed on Nov. 29, 2012 and incorporated herein by reference in its entirety. Other appetite suppressants may be present in addition to or as an alternative to Hoodia gordonii extract and can be envisioned by one having ordinary skill in the art.

In some embodiments, dietary supplements described herein can contain a delivery matrix suitable for being added to a foodstuff, niacin, and caffeine. The dietary supplements may be odorless and flavorless. As a result of being substantially odorless and flavorless, the dietary supplements described herein may not substantially change the taste and/or odor of a foodstuff when added thereto. Moreover, in some embodiments, the dietary supplements may not undesirably alter the consistency of a foodstuff when added thereto.

Delivery matrices suitable for being added to a foodstuff may include substances that are recognized as safe for consumption by a user and do not substantially alter the taste, odor and/or consistency of the foodstuff. In some embodiments, the delivery matrix can comprise a liquid matrix. Suitable liquid matrices may include any odorless and flavorless liquid medium that is recognized as safe for consumption by a user. In some embodiments, the liquid matrix may comprise water. Water can be a particularly advantageous liquid matrix due to its own health benefits and the ready solubility of caffeine, niacin and other various components therein. In some or other embodiments, the liquid matrix may comprise a mixture of water and an organic solvent. Suitable organic solvents that may optionally be present in a liquid matrix containing water include, for example, ethanol, glycerol, polyethylene glycol and the like. By pre-dissolving or dispersing the various components of the dietary supplements in a liquid matrix, a user can avoid the difficulties associated with dissolving and dispersing a solid substance in a food or beverage, thereby allowing a more uniform mixing of the dietary supplements in a foodstuff to be realized.

In some embodiments, the dietary supplements can be formulated in pre-mixed liquid unit dose serving sizes that a user can add, in their entirety, to a foodstuff of choice. In various embodiments, suitable liquid unit dose serving sizes for the dietary supplements can range between about 0.05 fluid ounces (1.48 mL) and about 2 fluid ounces (59.1 mL). In some embodiments, suitable liquid unit dose serving sizes for the dietary supplements can range between about 0.1 fluid ounces (2.96 mL) and about 1 fluid ounces (29.6 mL), or between about 0.25 fluid ounces (7.4 mL) and about 0.5 fluid ounces (14.8 mL). In some embodiments, a suitable liquid unit dose serving size for the dietary supplements can be about 0.25 fluid ounces (7.4 mL) or about 0.5 fluid ounces (14.8 mL). Depending on the type of foodstuff to which the dietary supplements are being added, it may be desirable to use smaller unit dose serving sizes in order to lessen the likelihood of changing the taste, odor or consistency of the foodstuff.

In other various embodiments, the dietary supplements can be pre-mixed in a bulk liquid delivery matrix that a user can add to a foodstuff of choice in a chosen amount. In such embodiments, an appropriate amount of the dietary supplements can be determined by the overall quantity of foodstuff that the dietary supplement is being added to and the expected volume of foodstuff that is anticipated to be consumed by a user at a given time.

In other various embodiments, the delivery matrix can comprise a solid matrix. Suitable solid matrices may include any odorless and flavorless solid medium that is recognized as safe for consumption by a user. In some embodiments, suitable solid matrices may include, for example, starches, cellulose and modified cellulose derivatives, sugars, sugar alcohols, gelatin, and the like. Use of a solid matrix may be desirable when uniform mixing of the dietary supplements with a foodstuff is not necessary or when dilution of a liquid foodstuff is a concern. For example, dietary supplements prepared with a solid delivery matrix may be applied by sprinkling a powdered or granulated formulation to a foodstuff as a condiment or topping.

In some embodiments, the dietary supplements can be packaged in premeasured solid unit dose serving sizes that a user can add, in their entirety, to a foodstuff of choice. In other embodiments, the dietary supplements can be packaged in a bulk solid delivery matrix that a user can add to a foodstuff in a chosen amount.

In some embodiments, a unit dose serving size of the dietary supplements may be substantially calorie-free. As used herein, the term “substantially calorie-free” will refer to a unit dose serving size of the dietary supplements that contains about 5 calories or less. In some embodiments, the dietary supplements may contain about 4 calories or less per serving, or about 3 calories or less per serving, or about 2 calories or less per serving, or about 1 calorie or less per serving.

Recommended daily allowance (RDA) values for various nutritional items are established by the U.S. Food and Drug Administration and will be known to one having ordinary skill in the art. As discussed hereinafter, in some embodiments, the present dietary supplements can beneficially provide a user with a significant fraction of the RDA of various nutritional components contained therein.

The RDA of niacin is about 14 mg/day for women and about 16 mg/day for men, and the recommended maximum daily intake is about 35 mg/day to avoid flushing. In some embodiments, the dietary supplements described herein can contain up to about 0.5% niacin by weight. In some embodiments, the dietary supplements can contain up to about 0.4% niacin by weight, or up to about 0.3% niacin by weight, or up to about 0.2% niacin by weight, or up to about 0.1% niacin by weight. In some embodiments, an amount of niacin in the dietary supplements may range between about 0.01% to about 0.3% (w/v) of the dietary supplement. In more specific embodiments, an amount of niacin in the dietary supplements may range between about 0.08% to about 0.3% (w/v) of the dietary supplement. In some embodiments, the dietary supplements can provide up to about 30% of the RDA of niacin in a single unit dose serving size.

In some embodiments, in addition to niacin, the dietary supplements may contain other nutritional components, such as one or more other B vitamins. For example, in some embodiments, the dietary supplements may contain one or more of pyroxidine hydrochloride (Vitamin B6), cyanocobalamin (Vitamin B12), pantothenic acid (Vitamin B5), any derivative thereof, or any combination thereof. In some embodiments, the dietary supplements can provide up to about 60% of the RDA of any of the foregoing B vitamins in a single unit dose serving size. For example, in some embodiments, a single unit dose serving size of the dietary supplements may provide up to about 1.2 mg of pyroxidine hydrochloride, up to about 3.6 μg of cyanocobalamin, and up to about 6 mg of pantothenic acid. In some embodiments, the dietary supplements can provide up to about 100% of the RDA of any of the foregoing B vitamins in a single unit dose serving size.

In some embodiments, the dietary supplements described herein can contain up to about 5% caffeine by weight. In some embodiments, the dietary supplements can contain up to about 4% caffeine by weight, or up to about 3% caffeine by weight, or up to about 2% caffeine by weight, or up to about 1% caffeine by weight. In some embodiments, an amount of caffeine in the dietary supplements may range between about 0.6% to about 3.4% (w/v) of the dietary supplement. In some or other embodiments, an amount of caffeine in the dietary supplements may range between about 0.6% to about 1.4% (w/v) of the dietary supplement, or between about 0.9% to about 1.4% of the dietary supplement, or between about 1.4% to about 2.7% (w/v) of the dietary supplement. In some embodiments, the dietary supplements may provide between about 50 mg to about 100 mg of caffeine in a single unit dose serving size. In some embodiments, the dietary supplements may provide between about 60 mg to about 80 mg of caffeine, or between about 80 mg to about 100 mg of caffeine, or between about 100 mg to about 150 mg of caffeine, or between about 150 mg to about 200 mg of caffeine in a single unit dose serving size. As discussed hereinbelow, in some embodiments, the caffeine may be provided from a natural source, such as green coffee bean extract, for example.

In some embodiments, the dietary supplements can optionally contain an appetite suppressant. In some embodiments, the appetite suppressant may comprise Hoodia gordonii extract. Hoodia gordonii extract has been traditionally used by the bushmen of South Africa for its appetite suppression properties. Without being bound by any theory or mechanism, it is believed that the primary active substance of Hoodia gordonii extract is a compound now commonly referred to in the art as P57, the structure of which is shown in Formula (1) below.

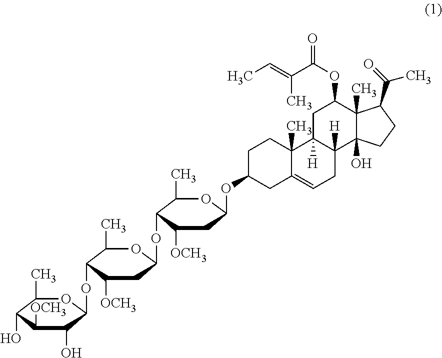

In some embodiments, the dietary supplements described herein can include green coffee bean extract, green tea extract, or any combination thereof. When present, green coffee bean extract can desirably provide at least a portion of the caffeine in the dietary supplements. In addition to providing a natural caffeine source for use in the dietary supplements, green coffee bean extract contains health-promoting antioxidants and is purported to promote weight loss. Without being bound by any theory or mechanism, it is believed that the weight loss effects of green coffee bean extract may be attributed to the chlorogenic acid found therein. In some embodiments, the amount of green coffee bean extract in the dietary supplements may be sufficient to supply substantially all the caffeine present therein.

In some embodiments, the dietary supplements described herein can contain green tea extract. Green tea extract is an herbal derivative of green tea leaves (Camellia sinensis), which contains a number of antioxidant compounds, mainly catechins, also known as green tea polyphenols. Illustrative but non-limiting examples of green tea polyphenols can include, for example, epigallocatechin gallate (EGCG), epigallocatechin, epicatechin gallate and epicatechin. Of these, EGCG is generally the primary constituent of a green tea extract. Other constituents of green tea extract can include, but are not limited to, caffeine and flavonoids such as, for example, kaempferol, quercetin and myricetin. In some embodiments, green tea extract may contain low amounts of caffeine or it may be substantially caffeine free. Green tea and its derivatives have long been considered a natural material that can promote beneficial health effects in a user. Without being bound by any theory or mechanism, it is believed that the catechins of green tea extract may activate phosphodiesterase to produce beneficial health effects.

In some embodiments, the dietary supplements described herein can contain up to about 0.05% green tea extract by weight. In some embodiments, the dietary supplements can contain up to about 0.04% green tea extract by weight, or up to about 0.03% green tea extract by weight, or up to about 0.02% green tea extract by weight, or up to about 0.01% green tea extract by weight. In some embodiments, an amount of green tea extract in the dietary supplements may range between about 0.005% to about 0.1% (w/v) of the dietary supplement. In some or other embodiments, an amount of green tea extract in the dietary supplements may range between about 0.008% to about 0.08% (w/v) of the dietary supplement, or between about 0.01% and about 0.05% of the dietary supplement, or between about 0.01% and about 0.03% (w/v) of the dietary supplement.

In some embodiments, the green tea extract may comprise about 90% or less polyphenols by weight. In other embodiments, the green tea extract may comprise about 80% or less polyphenols by weight, or about 70% or less polyphenols by weight, or about 60% or less polyphenols by weight, or about 50% or less polyphenols by weight, or about 40% or less polyphenols by weight, or about 30% or less polyphenols by weight, or about 20% or less polyphenols by weight, or about 10% or less polyphenols by weight.

In some embodiments, the dietary supplements may be substantially free of milk thistle extract.

In some embodiments, the dietary supplements may include a bioavailable chromium source. Bioavailable chromium sources may further promote appetite suppression and assist in glycemic control. Illustrative bioavailable chromium sources that may be present include, for example, chromium chloride, chromium nicotinate and chromium picolinate. The picolinate ligand particularly improves the bioavailability and solubility of this trace nutrient, making it an especially advantageous bioavailable chromium source for use in the dietary supplements described herein.

Although the dietary supplements described herein may be substantially odorless and flavorless, it is to be recognized that in alternative embodiments, the dietary supplements may be formulated to possess either an odor or a flavor. In some embodiments, various flavorants that will be familiar to one having ordinary skill in the art may be present in the dietary supplements described herein. In some or other embodiments, sugars and/or other carbohydrates may optionally be present in the dietary supplements. Sugars and other carbohydrates, in particular, may provide additional energy to a user and/or improve the taste of a foodstuff to which the dietary supplements are being applied. Although sugars or other carbohydrates may impart a flavor to the dietary supplements in some embodiments, it is to be recognized that in other embodiments, the quantities of these substances may be sufficiently small that the flavor of the dietary supplements is not substantially altered.

Likewise, in related embodiments, an artificial sweetener may be present in the dietary supplements for purposes similar to those in which a sugar or other carbohydrate is included. In some embodiments, the artificial sweetener stevia can be included in the dietary supplements. Stevia can be a particularly desirable artificial sweetener in this regard, since it is derived from natural sources and is generally recognized as safe.

In some embodiments, additional components such as, for example, preservatives can be present in the dietary supplements. Suitable preservatives will be familiar to one having ordinary skill in the art and may include, for example, citric acid, sodium benzoate, potassium sorbate, any derivative thereof, or any combination thereof.

In some embodiments, dietary supplements described herein may contain any combination of Hoodia gordonii extract, green tea extract, green coffee bean extract, a bioavailable chromium source, or one or more B vitamins. These components may be present in the dietary supplements in any of the concentration ranges set forth above.

In some embodiments, dietary supplements described herein can contain a liquid delivery matrix suitable for being added to a foodstuff; niacin; green coffee bean extract, containing caffeine; and green tea extract. In various embodiments, the dietary supplements may be odorless and flavorless. In other various embodiments, however, the dietary supplements may be flavored in one or more manners discussed above. In some embodiments, an amount of green tea extract in the dietary supplements may range between about 0.01% to about 0.03% (w/v) of the dietary supplement, an amount of niacin in the dietary supplement may range between about 0.08% to about 0.3% (w/v) of the dietary supplement, and an amount of caffeine in the dietary supplement may range between about 0.6% to about 3.4% (w/v) of the dietary supplement.

It is understood that modifications which do not substantially affect the activity of the various embodiments of this invention are also included within the definition of the invention provided herein. Accordingly, the following Examples are intended to illustrate but not limit the present invention.

### EXAMPLES

### Example 1

In one embodiment, the dietary supplements described herein can have a composition set forth in Table 1, where the serving size is 0.25 fluid ounces (7.4 mL). This formulation provides a user with about the same amount of caffeine as that present in 8 fluid ounces of premium coffee.

TABLE 1

| | Amount in 0.25 Fluid | |
|---|---|---|
| Component | Ounce Serving Size | |
| Total Carbohydrates | 1 | g |
| Sugars | 1 | g |
| Niacin | 6 | mg |
| Pyroxidine Hydrochloride | 1 | mg |
| (Vitamin B6) | | |
| Cyanocobalamin | 4 | μg |
| (Vitamin B12) | | |
| Pantothenic Acid | 6 | mg |
| (Vitamin B5) | | |
| Caffeine | 70 | mg |

### Example 2

In one embodiment, the dietary supplements described herein can have a composition set forth in Table 2, where the serving size is 0.25 fluid ounces (7.4 mL).

TABLE 2

| | Amount in 0.25 Fluid | |
|---|---|---|
| Component | Ounce Serving Size | |
| Total Carbohydrates | 1 | g |
| Sugars | 1 | g |
| Niacin | 6 | mg |
| Pyroxidine Hydrochloride | 1.2 | mg |
| (Vitamin B6) | | |
| Cyanocobalamin | 3.6 | μg |
| (Vitamin B12) | | |
| Pantothenic Acid | 6 | mg |
| (Vitamin B5) | | |
| Caffeine | 70 | mg |
| Green Tea Extract | 1.5 | mg |

### Example 3

In one embodiment, the dietary supplements described herein can have a composition set forth in Table 3, where the serving size is 8.1 fluid ounces (240 mL) and the added components total 115 mg.

TABLE 3

| Component | Amount Present | |
|---|---|---|
| Niacin | 10 | mg |
| Pyroxidine Hydrochloride | 1.2 | mg |
| (Vitamin B6) | | |
| Cyanocobalamin | 3.6 | μg |
| (Vitamin B12) | | |
| Pantothenic Acid | 6 | mg |
| (Vitamin B5) | | |
| Caffeine | 70 | mg |

| | |
|---|---|
| Maltodextrin | q.s. |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A dietary supplement comprising:
a delivery matrix suitable for being added to a foodstuff;
niacin; and
caffeine;
wherein the dietary supplement is odorless and flavorless.

2. The dietary supplement of claim 1, wherein the dietary supplement is substantially calorie-free.

3. The dietary supplement of claim 1, wherein the delivery matrix comprises a liquid matrix.

4. The dietary supplement of claim 3, wherein the liquid matrix comprises water.

5. The dietary supplement of claim 1, further comprising:
pyroxidine hydrochloride, cyanocobalamin, pantothenic acid, any derivative thereof, or any combination thereof.

6. The dietary supplement of claim 1, further comprising:
Hoodia gordonii extract, green tea extract, green coffee bean extract, a bioavailable chromium source, one or more B vitamins, or any combination thereof.

7. The dietary supplement of claim 1, further comprising:
green coffee bean extract, at least a portion of the caffeine being provided by the green coffee bean extract.

8. The dietary supplement of claim 7, further comprising:
green tea extract.

9. The dietary supplement of claim 8, wherein an amount of green tea extract in the dietary supplement ranges between about 0.01% to about 0.03% (w/v) of the dietary supplement.

10. The dietary supplement of claim 9, wherein an amount of niacin in the dietary supplement ranges between about 0.08% to about 0.3% (w/v) of the dietary supplement, and an amount of caffeine in the dietary supplement ranges between about 0.6% to about 3.4% (w/v) of the dietary supplement.

11. The dietary supplement of claim 1, wherein an amount of niacin in the dietary supplement ranges between about 0.01% to about 0.3% (w/v) of the dietary supplement.

12. The dietary supplement of claim 1, wherein an amount of caffeine in the dietary supplement ranges between about 0.6% to about 3.4% (w/v) of the dietary supplement.

13. The dietary supplement of claim 1, further comprising:
green tea extract.

14. The dietary supplement of claim 13, wherein an amount of green tea extract in the dietary supplement ranges between about 0.01% to about 0.03% (w/v) of the dietary supplement.

15. A dietary supplement comprising:
a liquid delivery matrix suitable for being added to a foodstuff;
niacin;
green coffee bean extract, containing caffeine; and
green tea extract;
wherein the dietary supplement is odorless and flavorless.

16. The dietary supplement of claim 15, wherein the dietary supplement is substantially calorie-free.

17. The dietary supplement of claim 15, wherein the liquid delivery matrix comprises water.

18. The dietary supplement of claim 15, further comprising:
pyroxidine hydrochloride, cyanocobalamin, pantothenic acid, any derivative thereof, or any combination thereof.

19. The dietary supplement of claim 15, further comprising:
Hoodia gordonii extract, a bioavailable chromium source, one or more B vitamins, or any combination thereof.

20. The dietary supplement of claim 15, wherein an amount of green tea extract in the dietary supplement ranges between about 0.01% to about 0.03% (w/v) of the dietary supplement.

21. The dietary supplement of claim 15, wherein an amount of niacin in the dietary supplement ranges between about 0.01% to about 0.3% (w/v) of the dietary supplement.

22. The dietary supplement of claim 15, wherein an amount of caffeine in the dietary supplement ranges between about 0.6% to about 3.4% (w/v) of the dietary supplement.

23. The dietary supplement of claim 15, wherein an amount of green coffee bean extract in the dietary supplement is sufficient to supply substantially all of the caffeine present therein.

24. The dietary supplement of claim 15, wherein an amount of green tea extract in the dietary supplement ranges between about 0.01% to about 0.03% (w/v) of the dietary supplement, an amount of niacin in the dietary supplement ranges between about 0.08% to about 0.3% (w/v) of the dietary supplement, and an amount of caffeine in the dietary supplement ranges between about 0.6% to about 3.4% (w/v) of the dietary supplement.

25. The dietary supplement of claim 24, further comprising:
pyroxidine hydrochloride, cyanocobalamin, pantothenic acid, any derivative thereof, or any combination thereof.

26. A foodstuff comprising the dietary supplement of claim 15.

27. The foodstuff of claim 26, wherein the foodstuff is selected from the group consisting of an alcoholic beverage, a carbonated beverage, water, a fruit juice, a vegetable juice, milk, a sports drink, a cooking oil, a salad dressing, a condiment, and a soup.
